(19) United States
(12) Patent Application Publication
(10) Pub. No.: US 2009/0244233 A1
(43) Pub. Date: Oct. 1, 2009

(54) INK JET RECORDING APPARATUS

(75) Inventors: Kazuhiko Ohtsu, Mishima-shi (JP); Masashi Hiroki, Yokohama-shi (JP); Satoshi Kaiho, Yokohama-shi (JP); Takashi Kado, Izunokuni-shi (JP); Atsushi Kubota, Sunto-gun (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/410,735

(22) Filed: Mar. 25, 2009

Related U.S. Application Data
(60) Provisional application No. 61/040,907, filed on Mar. 31, 2008.

(51) Int. Cl. B41J 2/01

(52) U.S. Cl. 347/102; 347/101

(57) ABSTRACT

An ink jet recording apparatus includes an ink jet head on which a plurality of nozzles are arranged, a sub-scan driving unit which carries a recording medium on which an image is formed, a first carrying unit which is disposed on a downstream side of a carrying direction of the recording medium by the sub-scan driving unit and carries the recording medium on which an image is formed by the ink jet head, a second carrying unit which is disposed on a downstream side of the first carrying unit along a carrying direction of the recording medium, and a heating unit which is disposed between the first carrying unit and the second carrying unit.

### CROSS-REFERENCE TO RELATED APPLICATION

This application claims the benefit of U.S. Provisional Application No. 61/040,907, filed Mar. 31, 2008.

### TECHNICAL FIELD

The present invention relates to an ink jet recording apparatus which ejects aqueous ink from an ink jet head to form an image on a paper.

### BACKGROUND

An ink jet recording apparatus can record an image with high accuracy at high speed. Further, the ink jet recording apparatus adopts a non-impact system, so that noises are few. Moreover, the ink jet recording apparatus has an advantage that a color image is easily recorded by using multicolored inks. Therefore, the ink jet recording apparatus becomes a common practice for home or official use.

In general, users use an ink jet dedicated and coated paper or a mat coated paper or the like which is provided with a coated layer with high ink absorbability as a paper used in the ink jet recording apparatus. However, a cost of the ink jet dedicated and coated paper or the like is high, the feeling of writing is lacked and the like. For these reasons, in recent years, the users use a PPC plain paper for printing of the ink jet recording apparatus in many cases.

When the ink jet recording apparatus performs the printing on the plain paper by using the aqueous ink jet ink and thus an image is formed in the plain paper, moisture in ink makes the paper fiber swollen or chemical bond is dissolved, so that cockling or curl is generated. Further, in the plain paper, there are problems in that feathering is generated because the ink is spread wet on a plain paper fiber by an effect of delayed dryness and spread in ink, or bleed caused by mixing different colors occurs, so that the image quality is worsened.

In the ink jet recording apparatus, a cellulose fiber is swollen or loosen especially in a plain paper by moisture in the inks, and a phenomenon as referred to as the cockling or the curl occurs in the paper in a period of several to tens mm. For this reason, there is the defect that it is difficult for users to handle the paper after being printed.

In the ink jet recording apparatus, when the ink is not naturally dried on the printed paper or it is difficult to be dried, a heating dryer such as a warm air fan or a conductive heat-generating element is provided in order to forcibly dry a printed portion or a recorded portion on the paper.

In JP-A-10-217572, a configuration of an ink jet printer is disclosed in which while an ink jet head and a recording sheet are separated from each other, in a recording area where an ink is applied on the recording sheet, the back surface of the recording sheet is supported by a mesh member having a heater which is disposed at an opposite side to the ink jet head.

The configuration of the ink jet printer described in JP-A-10-217572 is as follows. In the recording area where the ink is applied on the recording sheet while the ink jet head and the recording sheet are separated from each other, the ink jet printer is provided with the mesh member which supports the back surface side of the recording sheet, and the heater which is provided in the mesh member and is used for fixing the recording image from the back surface side of the recording sheet, so that a distance between the heater and the recording sheet is shorted and the heat of the heater is directly transferred to the recording sheet. Therefore, in the ink jet printer, a heating effect is sufficiently exhibited even though the recording sheet does not come into contact with the heater over the entire surface thereof, and further the vapor which is evaporated from the back surface of the recording sheet is always removed from the recording area to the outside. Therefore, a difference between degrees of dryness on both sides of the recording sheet is reduced, and thus a bending of the recording sheet is significantly reduced or removed.

However, in the configuration of the ink jet printer described in JP-A-10-217572, since the paper is heated from the back surface of the paper through the guide member having the mesh structure, efficiency in transferring the heat to the back surface of the paper is low. Especially, in one-path high speed printing apparatus where an ink jet head having the same width as the paper is used, it is difficult to remove the moisture which is contained in the paper.

In addition, feathering or bleed of the image on the plain paper can be improved, and the cockling or the curl which is generated on the recording medium made of the plain paper can not be efficiently improved.

An object of the present invention is to provide an ink jet recording apparatus, which can efficiently dry a paper on which an image is formed by using ink.

### SUMMARY

According to one aspect of the present invention, there is provided an ink jet recording apparatus including: an ink jet head on which a plurality of nozzles are arranged; a sub-scan driving unit which carries a recording medium to be formed with an image; a first carrying unit which is disposed on a downstream side of a carrying direction of the recording medium by the sub-scan driving unit and carries the recording medium where an image is formed by the ink jet head; a second carrying unit which is disposed on a downstream side of the first carrying unit along a carrying direction of the recording medium; and a heating unit which is disposed between the first carrying unit and the second carrying unit.

### DESCRIPTION OF THE DRAWINGS

FIG. 1 is a cross-sectional view illustrating an ink jet recording apparatus viewed from a horizontal direction according to a first embodiment.

FIG. 2 is a cross-sectional view illustrating a heat-fixing device viewed from a horizontal direction according to the first embodiment.

FIG. 3 is a cross-sectional view illustrating a heat-fixing device viewed from a horizontal direction according to a second embodiment.

FIG. 4 is a cross-sectional view illustrating a heat-fixing device viewed from a horizontal direction according to a third embodiment.

FIG. 5 is a cross-sectional view illustrating a heat-fixing device viewed from a horizontal direction according to a fourth embodiment.

FIG. 6 is a cross-sectional view illustrating a modified example of the heat-fixing device viewed from a horizontal direction according to the first embodiment.

FIG. 7 is a cross-sectional view illustrating a modified example of the heat-fixing device viewed from a horizontal direction according to the first embodiment.

FIG. 8 is a block diagram illustrating a control system of the ink jet recording apparatus according to the first embodiment.

### DETAILED DESCRIPTION

Hereinafter, embodiments will be described.

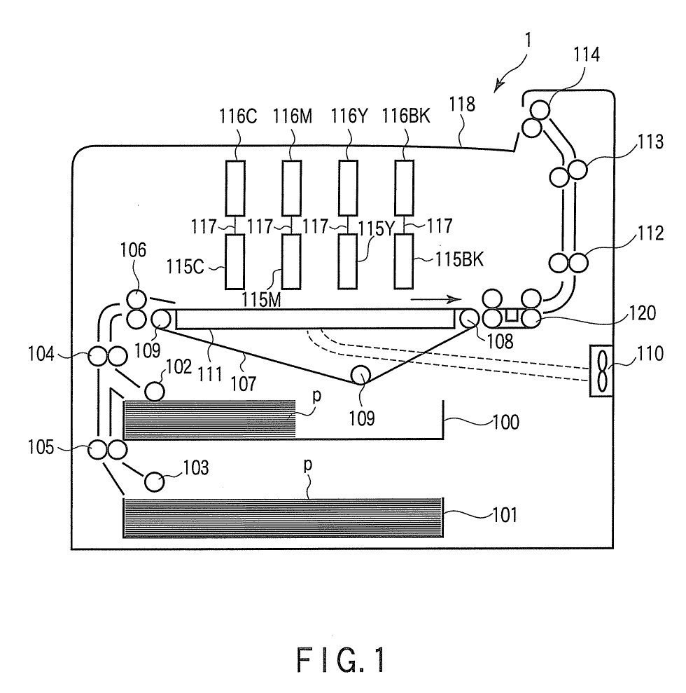

FIG. 1 is a cross-sectional view illustrating an ink jet recording apparatus 1 viewed from a horizontal direction according to a first embodiment. A first paper cassette 100 and a second paper cassette 101 contain the recording mediums p which are different in size, respectively. A first paper feeding roller 102 withdraws the recording medium p corresponding to a selected recording medium size from the first paper cassette 100 to be carried to a pair of first carrying rollers 104 and a pair of resist rollers 106. Similarly, a second paper feeding roller 103 withdraws the recording medium p corresponding to a size of the selected recording medium from the second paper cassette 101 to be carried to a pair of second carrying rollers 105, the pair of first carrying rollers 104, and the pair of resist rollers 106.

A carrying belt 107 is applied with tension by a driving roller 108 and two driven rollers 109. In a surface of the carrying belt 107, holes are made at a predetermined interval. In addition, in the inside of the carrying belt 107, a negative pressure chamber 111 is provided so as to be connected to a fan 110 in order to adsorb the recording medium p to the carrying belt 107.

The driving roller 108 drives the carrying belt 107 so as to carry the recording medium p from an upstream side on which the pair of the resist rollers 106 are formed as a paper feeding unit to a downstream side on which a pair of first carrying rollers 112, a pair of second carrying rollers 113, and a pair of third carrying rollers 114 are formed as the paper feeding unit. A carrying direction of the recording medium p is a sub-scan direction when it is viewed from a recording operation in the ink jet recording apparatus 1.

In the downstream side of the carrying direction of the recording medium p on the carrying belt 107, a heat-fixing device 120 which heats the image-formed recording medium p, the pair of the first carrying rollers 112, the pair of the second carrying rollers 113, and the pair of the third carrying rollers 114 are disposed. The heat-fixing device 120 will be described in detail later.

Above the carrying belt 107, ink jet heads which eject inks to the recording medium according to printing data are disposed on four lines.

Specifically, from the upstream side, an ink jet head 115C which ejects a cyan (C) ink, an ink jet head 115M which ejects a magenta (M) ink, an ink jet head 115Y which ejects a yellow (Y) ink, and an ink jet head 115Bk which ejects a black (Bk) ink are disposed in this order.

In the ink jet heads 115C, 115M, 115Y, and 115Bk, nozzles which eject the inks are disposed at a predetermined resolution along a width direction of the recording medium p, respectively. That is, the ink jet heads 115C, 115M, 115Y, and 115Bk are line type print heads in which plural nozzles (not shown) are arranged on a line. In the ink jet heads 115C, 115M, 115Y, and 115Bk, the nozzles are arranged in a direction perpendicular to the carrying direction of the recording medium p by the carrying belt 107. These nozzles are arranged so as to be positioned with a defined distance with respect to the recording medium p which is located on the carrying belt 107. Here, an alignment direction of the nozzles is a main scan direction.

The ink jet recording apparatus 1 according to the first embodiment, the line type ink jet heads 115C, 115M, 115Y, and 115Bk are provided on the carrying belt 107 which carries the recording medium p. The nozzles are provided on end surfaces of main bodies of the ink jet heads 115C, 115M, 115Y, and 115Bk at a predetermined pitch. Further, in the ink jet heads 115C, 115M, 115Y, and 115Bk, actuators are provided on positions facing the nozzles through ink chambers, respectively.

The actuator includes an oscillation plate and a piezoelectric element which are attached on the top of partition walls which separate each ink chamber. When a voltage is applied to the piezoelectric element by a driving signal according to a pixel pattern, the oscillation plate is deformed. A pressure according to a volume change of the ink chamber is propagated to the ink in the ink chamber, and thus the ink is ejected from the nozzles. The arrangement pitch of the nozzles is properly selected by a pixel density to be printed. In this way, the ink jet heads 115C, 115M, 115Y, and 115Bk performs the recording operation to the recording medium p on the basis of an image signal to be inputted.

Here, as a gradation printing adapted to the ink jet printer, there is an area gradation method in which one pixel is made of plural dots in a matrix shape without changing an ink droplet size such as a dither method and the gradation is expressed by changing the number of dots in the pixel. Further, as the gradation printing, there is a density gradation method in which a density of one dot is changed by changing the ink droplet size. In addition, as the gradation printing, there is a multi drop driving method of gradating the density, in which the number of the ink droplets to be injected for one dot is changed without changing the ink droplet size. These methods have advantages and disadvantages, and a proper printing method is used according to applications. In the first embodiment, the multi drop driving method which is used as the recording method will be described.

Further, any driving method can be used as long as the ink jet heads 115C, 115M, 115Y, and 115Bk are a line type. That is, in the ink jet heads 115C, 115M, 115Y, and 115Bk, a method of using thermoelectric conversion elements, a method of using electrostrictive conversion elements, or other methods of an ink ejection method are applicable.

The carrying belt 107 and the driving roller 108 are sub-scan driving units which relatively move the recording medium p and the ink jet heads 115C, 115M, 115Y, and 115Bk in the sub-scan direction perpendicular to the alignment direction of the nozzles. That is, the carrying belt 107 and the driving roller 108 perform a sub-scan driving process in which the recording medium p and the ink jet heads 115C, 115M, 115Y, and 115Bk are relatively moved in the sub-scan direction perpendicular to the alignment direction of the nozzles.

That is, the ink jet recording apparatus 1 according to the first embodiment performs the recording operation on the recording medium p in the line scheme (one path recording scheme).

Further, in the ink jet heads 115C, 115M, 115Y, and 115Bk, a cyan (C) ink cartridge 116C, a magenta (M) ink cartridge 116M, a yellow (Y) ink cartridge 116Y, and a black (Bk) ink cartridge 116Bk in which respective colors are filled are provided. The ink jet head 115C and the ink cartridge 116C, the ink jet head 115M and the ink cartridge 116M, the ink jet head 115Y and the ink cartridge 116Y, and the ink jet head 115Bk and the ink cartridge 116Bk are connected through tubes 117, respectively.

Here, an example of composition in aqueous inks of black, yellow, cyan, and magenta will be shown.

Black1

| | |
|---|---|
| Self-dispersed carbon black | 8.0 wt % |
| dispersion liquid | |
| (Made by Cabot Specialty | |
| Chemicals Ink) | |
| (Carbon black solid content | |
| concentration) | |
| Glycerin | 30.0 wt % |
| Ethylene glycol mono butyl ether | 0.5 wt % |
| Surfynol 465 | 1.0 wt % |
| Proxel XL-2 (S) | 0.2 wt % |
| Ion-exchange water | remaining amount (60.3 wt %) |

Black2

| | |
|---|---|
| Self-dispersed carbon black | 8.0 wt % |
| dispersion liquid | |
| (Made by Cabot Specialty | |
| Chemicals Ink) | |
| (Carbon black solid content | |
| concentration) | |
| Glycerin | 30.0 wt % |
| Ethylene glycol | 10.0 wt % |
| Diethylene glycol mono butyl ether | 5.0 wt % |
| Surfynol 465 | 1.0 wt % |
| Proxel XL-2 (S) | 0.2 wt % |
| Ion-exchange water | remaining amount (45.8 wt %) |

Yellow

| | |
|---|---|
| Self-dispersion yellow | 6.0 wt % |
| dispersion liquid | |
| (Made by Cabot Specialty | |
| Chemicals Ink) | |
| (Yellow pigment solid content | |
| concentration) | |
| Glycerin | 45.0 wt % |
| Ethylene glycol mono butyl ether | 5.0 wt % |
| Surfynol 465 | 1.0 wt % |
| Proxel XL-2 (S) | 0.2 wt % |
| Ion-exchange water | remaining amount (42.8 wt %) |

Magenta

| | |
|---|---|
| Polymer dispersant dispersed | 6.0 wt % |
| magenta dispersion liquid | |
| (Made by Fuji Shikiso) | |
| (Magenta pigment solid content | |
| concentration) | |
| Glycerin | 45.0 wt % |
| Diethylene glycol mono butyl ether | 5.0 wt % |
| Surfynol 465 | 1.0 wt % |
| Proxel XL-2 (S) | 0.2 wt % |
| Ion-exchange water | remaining amount (42.8 wt %) |

Cyan

| | |
|---|---|
| Polymer dispersant dispersed | 6.0 wt % |
| cyan dispersion liquid | |
| (Made by Fuji Shikiso) | |
| (Cyan pigment solid content | |
| concentration) | |
| Glycerin | 45.0 wt % |
| Triethylene glycol mono butyl ether | 5.0 wt % |
| Surfynol 465 | 1.0 wt % |
| Proxel XL-2 (S) | 0.2 wt % |
| Ion-exchange water | remaining amount (57.2 wt %) |

The above-mentioned ink includes water of 60.3 wt % as a maximum value or 42.8 wt % as a minimum value. Before the image is completely formed, it is necessary to dry the recording medium by evaporating the moisture down to an amount of moisture in order not to affect at least the cockling or the curl.

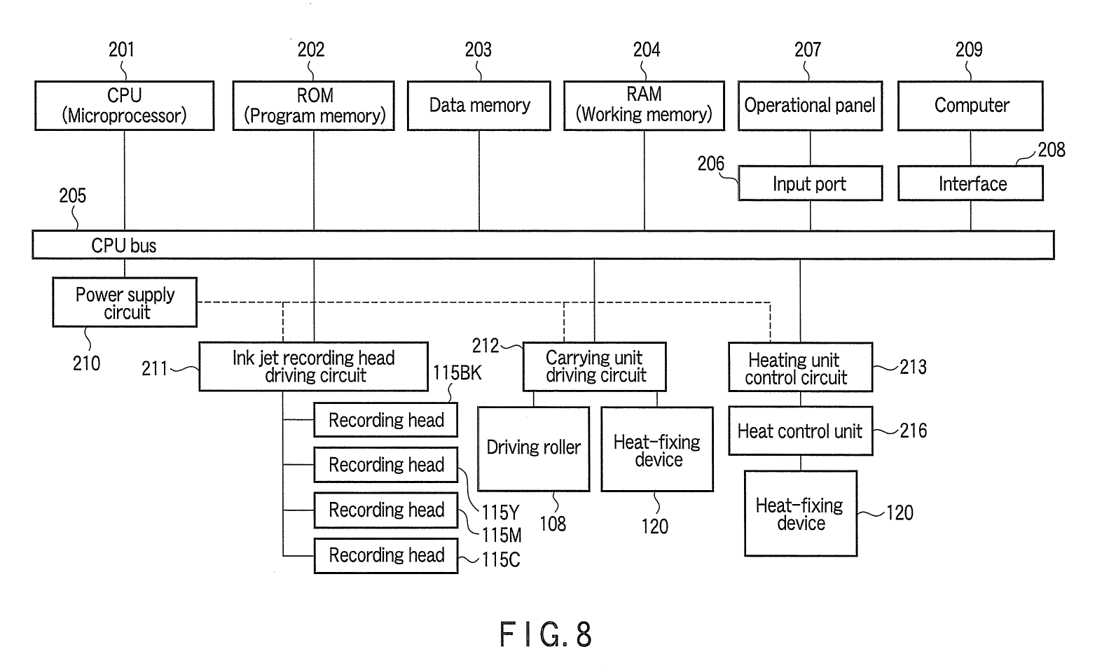

FIG. 8 is a block diagram illustrating an image formation and a control system of the ink jet recording apparatus 1 according to the first embodiment.

The control system of the ink jet recording apparatus 1 is provided with a CPU (microprocessor) 201, a ROM (program memory) 202 and a RAM (working memory) 204 which establish a microcomputer which is connected to the CPU 201 via a bus, a data memory 203 which stores data, and an operational panel 207 via an input port 206 or the like. The operational panel 207 is provided to display detailed settings of an operation environment of the ink jet recording apparatus 1, or an operation state of an operating process. The operational panel 207 displays and sets by giving feedback of operation signals from respective driving circuits.

The CPU (microprocessor) 201 controls a power supply circuit 210, an ink jet recording head driving circuit 211, a carrying unit driving circuit 212, and a heating unit control circuit 213, respectively. In addition, the CPU 201 controls each unit of the ink jet recording apparatus 1 to be driven. The CPU 201 controls each unit according to an operating program which is stored in the ROM 202 or the data memory 203.

The power supply circuit 210 supplies electric power to each unit, and simultaneously outputs a driving voltage of each ink jet recording head 115, a motor driving voltage for driving the heat-fixing device 120, and an operating voltage for heating.

The ink jet recording head driving circuit 211 transfers driving signals to the ink jet heads 115C, 115M, 115Y, and 115Bk. The carrying unit driving circuit 212 controls the driving roller 108 for driving the carrying belt 107 and rollers which are used for carrying and driving in the heat-fixing device 120.

The heating unit control circuit 213 transfers the driving signal to a heat control unit 216. The heat control unit 216 controls a heating temperature in the heat-fixing device 120 and on/off between a heating period.

Next, the image formation by the ink jet recording apparatus 1 according to the first embodiment will be described. Firstly, when CPU 201 obtains a command or printing data which is transmitted from a computer 209 via an interface 208, to be printed on the recording medium p, the CPU 201 transfers the received data or the command to the RAM 204. The CPU 201 processes the printing data to be an image on the basis of the operating program stored in the ROM 202 and the command data stored in the data memory 203. The CPU 201 controllably drives each unit of the ink jet recording apparatus 1 in the operating process according to the operating program, and controls each unit to record the image on the recording medium p.

The CPU 201 transmits the image-processed printing data to the ink jet recording head driving circuit 211. The ink jet recording head driving circuit 211 transmits the driving signals to the ink jet heads 115C, 115M, 115Y, and 115Bk. Here, the ink jet heads 115C, 115M, 115Y, and 115Bk are connected with the respective colors of the ink cartridges 116C, 116M, 116Y, and 116Bk through the tubes 117, respectively. The ink jet heads 115C, 115M, 115Y, and 115Bk is supplied with proper inks on the basis of the printing data. The ink jet heads 115C, 115M, 115Y, and 115Bk selectively ejects the inks as multi-drop ink droplets from the nozzles on the recording medium p according to the driving signals. This process is referred to as a main scan driving process.

Further, the CPU 201 controls the driving roller 108 and the heat-fixing device 120 to be driven by the carrying unit driving circuit 212. The CPU 201 relatively moves the ink jet heads 115C, 115M, 115Y, and 115Bk and the recording medium p in the sub-scan direction by the driving roller 108 and the heat-fixing device 120. This process is referred to as a sub-scan driving process. The recording operation is performed by the main scan driving process and the sub-scan driving process.

Here, the CPU 201 drives the ink jet recording head driving circuit 211 in synchronization with timing for carrying the recording medium p by the carrying unit driving circuit 212 according to the printing data, and controls the ink jet heads 115C, 115M, 115Y, and 115Bk to eject the ink.

Further, the CPU 201 simultaneously transmits the driving signal to the carrying unit driving circuit 212 and the heating unit control circuit 213.

The first paper feeding roller 102 or the second paper feeding roller 103 withdraws the recording medium p of the selected recording medium size from the first paper cassette 100 or the second paper cassette 101 one by one. The recording medium p is carried to the pair of the first carrying rollers 104 or the pair of the second carrying rollers 105 and the pair of the resist rollers 106.

The pair of the resist rollers 106 correct skew of the recording medium p, and begin to carry the recording medium at a predetermined timing. The negative pressure chamber 111 drives the fan 110 so as to be reduced in pressure, and thus air is sucked through the holes of the carrying belt 107. The recording medium p which is adsorbed on the carrying belt 107 is carried to a position facing to the ink jet heads 115C, 115M, 115Y, and 115Bk. Therefore, a distance between the recording medium p and the ink jet heads 115C, 115M, 115Y, and 115Bk is maintained at a constant interval, for example, 0.5 to 2.0 mm.

The CPU 201 is synchronized with the timing when the recording medium p is carried from the pair of the resist rollers 106, and ejects the inks of the respective colors from the ink jet heads 115C, 115M, 115Y, and 115Bk. Since the nozzles of the ink jet heads 115C, 115M, 115Y, and 115Bk are arranged along the width direction of the recording medium p, when the recording medium p is carried, a full color image is formed on the entire surface of the recording medium p.

After the Bk ink ejected from the ink jet head 115Bk is finally landed on the recording medium p and predetermined time lapses, the carrying belt 107 carries the recording medium p to the heat-fixing device 120. The heat-fixing device 120 is embedded in the negative pressure chamber 111 at a position on the downstream of the ink jet head 115Bk along the carrying direction of the recording medium p. The heat-fixing device 120 is a mechanism for evaporating the moisture which is included in the recording medium p in the middle of being passed. The head-fixing device 120 dries the recording medium p to an amount of moisture in order not to affect at least the cockling or the curl. The recording medium p is discharged to a discharge tray 118 by the pair of the first carrying rollers 112, the pair of the second carrying rollers 113, and the pair of the third carrying rollers 114.

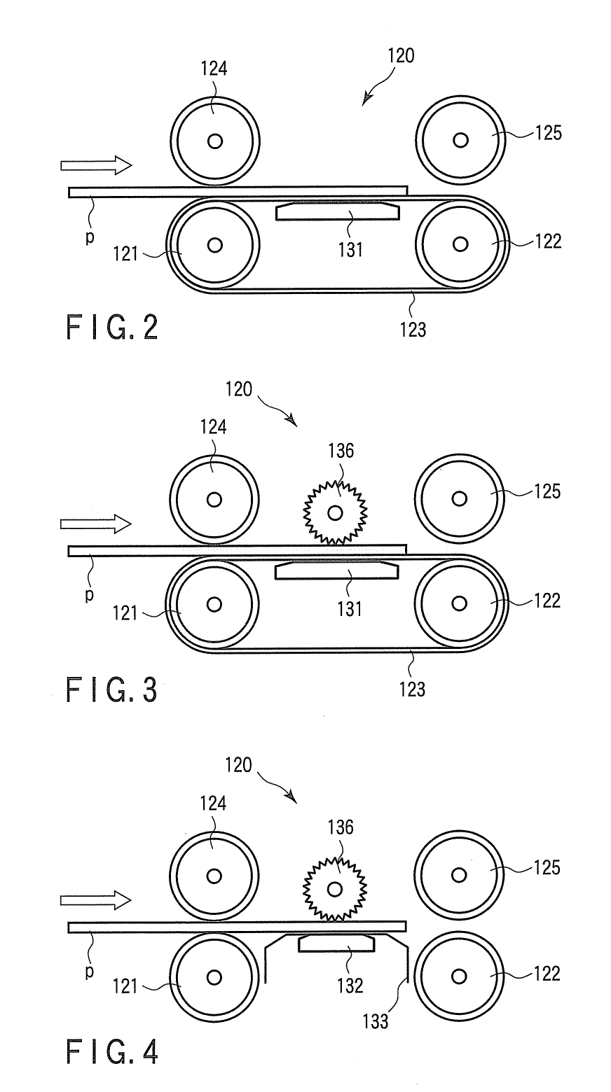

FIG. 2 is a cross-sectional view illustrating the heat-fixing device 120 viewed from a horizontal direction according to the first embodiment.

As shown in FIG. 2, in the heat-fixing device 120, a lower roller 121, a heat resistant heat carrying belt 123 which is hung on the lower roller 122, and a heat carrying roller 124 and a heat carrying roller 125 which face the lower roller 121 and the lower roller 122, respectively, are disposed. The heat carrying roller 124 and the heat carrying roller 125 are disposed on an upper side of the lower roller 121 and the lower roller 122 along a height direction, respectively. Here, the CPU 201 drives the lower roller 121 via the carrying unit driving circuit 212. The heat carrying belt 123 is driven by the rotation of the lower roller 121. As the lower roller 121 is rotated, the heat carrying roller 124 and the heat carrying roller 125 are rotatably driven.

Therefore, the heat carrying belt 123, the heat carrying roller 124, and the heat carrying roller 125 carry the recording medium p at the same speed in the same direction. An arrow shown in FIG. 2 shows a carrying direction of the recording medium p. Here, the relation between driving and driven is only an example, even if the relation between driving and driven is changed or the rollers are separately operated, it may be applicable as long as the lower roller 121, the heat carrying roller 124, and the heat carrying roller 125 are rotated in synchronization with one another.

The heat carrying belt 123 include a metal conductive layer and a solid rubber layer in order from the inside thereof. As a material of the metal conductive layer, for example, nickel (having a thickness of 40 to 100 μm) is used. In the metal conductive layer, stainless steel, aluminum, and a composite material of stainless steel and aluminum may be used. The solid rubber layer includes a silicon rubber having a thickness of 200 μm.

Further, in the heat-fixing device 120, a heater 131 is disposed so as to come into contact with the back surface side of the heat carrying belt 123 which is hung on the lower roller 121 and the lower roller 122. The heat control unit 216 controls the heater 131 by signals of the heat control circuit 215 such that a surface temperature of the recording medium p which is carried on the surface of the heat carrying belt 123 becomes 30° C. or more, preferably 40° C. to 80° C. At that time, the heat control unit 216 controls the heater 131 such that the surface temperature of the heater 131 becomes about 100° C. to 200° C.

When the heater 131 is heated up to a predetermined temperature, the CPU 201 allows the above-mentioned ink jet heads 115C, 115M, 115Y, and 115Bk to perform the recording operation. When the heat carrying belt 123, the upper roller 124 and the upper roller 125 interpose the image-formed recording medium p therebetween to be carried to the heater 131, the heat is transferred to the recording medium p by the heater 131 which is provided on the heat carrying belt 123. At that time, in the image-formed recording medium p which contains the moisture in ink, the evaporation of the moisture is accelerated.

Since the surface side of the heat carrying belt 123 is opened, the vapor generated from the recording medium p is efficiently diffused to external air. Here, since the vapor generated from the recording medium p is basically diffused to the upper side, if a press roller or a plate or the like which obstructs evaporation of the moisture is disposed on the upper side of the recording medium p, the moisture is not evaporated smoothly. Therefore, when nothing is disposed on the upper side of the recording medium p, the moisture is efficiently evaporated. In the recording medium p which is passed through the heat-fixing device 120, feathering or bleed of the image is improved, and the cockling (paper wrinkle) disappears and the curl is decreased.

Further, the upper roller 124 and the lower roller 121, and the upper roller 125 and the lower roller 122 carry the recording medium p so as to be interposed therebetween at the same speed. For this reason, the heat-fixing device 120 does not cause wrinkles or deformation on the recording medium p which can be carried to the pair of the first carrying rollers 112 and subsequent part.

The CPU 201 properly controls the heat control circuit 215 by a carrying speed or environmental conditions in order to be an optimal carrying speed and an optimal set temperature of the recording medium p which are stored in the data memory 203 in advance. This is because, when the moisture is extremely evaporated from the recording medium p by an excessive heat, the cockling or the curl in the recording medium is accelerated.

The heater 131 is configured to attach a heat-generating resistor to a housing which is made of aluminum or heat resistant resin. However, it is not limited thereto, and a ceramic heater, a rubber heater, or a halogen heater may be applicable.

Next, a second embodiment will be described with reference to FIG. 3. FIG. 3 is a cross-sectional view illustrating the heat-fixing device 120 viewed from a horizontal direction according to the second embodiment. The heat-fixing device 120 according to the second embodiment is configured to use a star wheel 136 in addition to the heat-fixing device 120 according to the first embodiment. The description of the same configuration and operation as those in the embodiment shown in FIG. 2 will be omitted.

The star wheel 136 is an anti-float member for the recording medium p, and a porous roller such as urethane foam may be applicable. The star wheel 136 is disposed at a position between the upper roller 124 and the upper roller 125 along the carrying direction of the recording medium p and a position facing the heater 131 such that the heat carrying belt 123 and the recording medium p are interposed. The star wheel 136 has plural teeth on a circumference of circle along the carrying direction of the recording medium p. The star wheel 136 is driven as the lower roller 121 is rotated. In addition, the star wheel 136 is rotatably driven while pushing the recording medium p to the heat carrying belt 123.

The star wheel 136 prevents the recording medium p heated by the heater 131 from floating from the heat carrying belt 123 as much as possible. Since the star wheel 136 prevents the recording medium p from floating, the heater 131 can efficiently propagate the heat to the recording medium p. Moreover, the star wheel 136 is configured not to block the surface of the recording medium p, as it can be, so that the generated vapor is not prevented from being diffused.

It is sufficient that the star wheel 136 has performance to achieve the above-mentioned effects, and the material may be metal or resin and the number of teeth of the wheel may be arbitrary. In addition, the star wheel 136 may be a cylindrical roller which is configured to be a hive-like shape. Further, the star wheel 136 may be a sponge-shaped roller which is provided with a large opening area by foaming a heat resistant resin.

Next, a third embodiment will be described with reference to FIG. 4. FIG. 4 is a cross-sectional view illustrating the heat-fixing device 120 viewed from a horizontal direction according to the third embodiment. In the heat-fixing device 120 according to the third embodiment, the heat carrying belt 123 is removed from the heat-fixing device 120 according to the second embodiment, and a heating guide 133 is used. The description of the same configuration and operation as those in the embodiments shown in FIG. 2 and FIG. 3 will be omitted.

The heat-fixing device 120 is disposed on the upstream side along the carrying direction of the recording medium p with respect to the lower roller 121 and the upper roller 124. The heat-fixing device 120 is disposed on the downstream side along the carrying direction of the recording medium p with respect to the lower roller 122 and the upper roller 125. A heater 132 and the heating guide 133 are disposed between the pair of the lower roller 121 and the upper roller 124 and the pair of the lower roller 122 and the upper roller 125. The heating guide 133 guides the recording medium p so as not to be hung down between the pair of the lower roller 121 and the upper roller 124 and the pair of the lower roller 122 and the upper roller 125. That is, a contact point between the pair of the lower roller 121 and the upper roller 124 and the recording medium p, a contact surface between the heating guide 133 and the recording medium p, and a contact point between the pair of the lower roller 122 and the upper roller 125 and the recording medium p become flush with one another along the carrying direction of the recording medium p.

In addition, the heater 132 is disposed so as to come into contact with the lower side of the heating guide 133. The heater 132 heats the recording medium p via the heating guide 133. As described in the first embodiment, the heat control unit 216 controls the heater 132 by signals of the heat control circuit 215 such that the surface temperature of the recording medium p becomes 30° C. or more, preferably 40° C. to 80° C.

In addition, similar to the second embodiment shown in FIG. 3, a star wheel 136 is provided on the upper side of the heating guide 133. The star wheel 136 is rotatably driven while pushing the recording medium p to the heating guide 133.

Here, the CPU 201 drives the lower roller 121 by the carrying unit driving circuit 212. The lower roller 122, the upper roller 124, the upper roller 125, and the star wheel 136 are driven as the lower roller 121 is rotated. Therefore, the lower roller 121, the lower roller 122, the upper roller 124, the upper roller 125, and the star wheel 136 carry the recording medium p at the same speed in the same direction along the carrying direction of the recording medium p shown by an arrow. Here, the relation between driving and driven is only an example, even if the relation between driving and driven is changed or the rollers are separately operated, it may be applicable as long as the lower roller 121, the lower roller 122, the upper roller 124, the upper roller 125, and the star wheel 136 are rotated in synchronization with one another.

As described in the above-mentioned third embodiment, even though the heat carrying belt 123 as shown in the second embodiment is not used, it is possible to obtain the same effect with a simple configuration by using the heating guide 133. In addition, when the contact surface between the heating guide 133 and the recording medium p is disposed so as to become flush with or above a line which connects the contact point between the pair of the lower roller 121 and the upper roller 124 and the recording medium p and the contact point between the pair of the lower roller 122 and the upper roller 125 and the recording medium p, the recording medium p is pushed in order to be applied with tension. For this reason, the heating guide 133 is disposed so as to come into close contact with the recording medium p, so that the recording medium p can be efficiently heated.

Since the star wheel 136 is disposed in the heat-fixing device 120, the same effects as those in the second embodiment shown in FIG. 3 can be obtained.

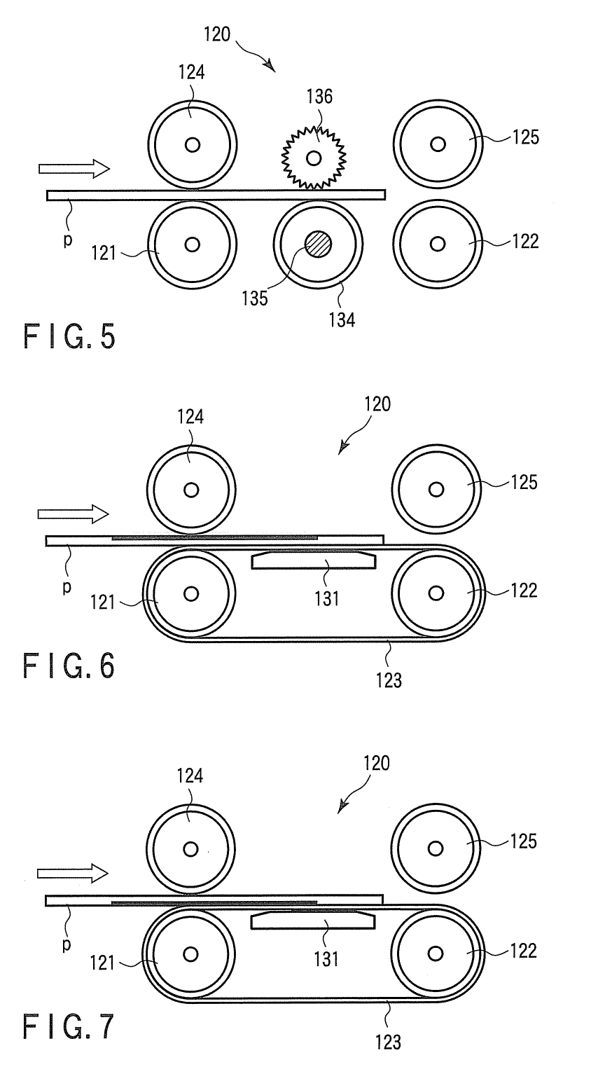

Next, a fourth embodiment will be described with reference to FIG. 5. FIG. 5 is a cross-sectional view illustrating the heat-fixing device 120 viewed from a horizontal direction according to the fourth embodiment. In the heat-fixing device 120 according to the fourth embodiment, the heating guide 133 and the heater 132 are removed from the heat-fixing device 120 according to the third embodiment, and a heat pipe 134 which is provided with the halogen lamp 135 is used. The description of the same configuration and operation as those in the embodiments shown in FIG. 2, FIG. 3 and FIG. 4 will be omitted.

The heat pipe 134 which is provided with the halogen lamp 135 is disposed between the pair of the lower roller 121 and the upper roller 124 and the pair of the lower roller 122 and the upper roller 125. A contact point between the heat pipe 134 and the recording medium p becomes flush with a contact point between the recording medium p and the pair of the lower roller 121 and the upper roller 124, a contact point between the heat pipe 134 and the recording medium p, and a contact point between the pair of the lower roller 122 and the upper roller 125 and the recording medium p along the carrying direction of the recording medium p.

The heat pipe 134 is driven as the lower roller 121 is driven by the carrying unit driving circuit 212. Therefore, the lower roller 121, the lower roller 122, the upper roller 124, the upper roller 125, the star wheel 136, and the heat pipe 134 carry the recording medium p at the same speed in the same direction along the carrying direction of the recording medium p shown in an arrow. Here, the relation between driving and driven is only an example, even if the relation between driving and driven is changed or the rollers are separately operated, it may be applicable as long as the lower roller 121, the lower roller 122, the upper roller 124, the upper roller 125, the star wheel 136, and the heat pipe 134 are rotated in synchronization with one another.

The heat control unit 216 controls the halogen lamp 135 by signals of the heat control circuit 215 such that the surface temperature of the recording medium p which is carried on the surface of the heat pipe 134 becomes 30° C. or more, preferably 40° C. to 80° C. Here, an IH heater may be used in the heat pipe 134 instead of the halogen lamp 135. Further, for example, a roller made of a metal material such as iron may be used instead of the heat pipe 134, and an IH coil may be provided therein. Here, the heat occurs from the roller by an eddy-current which is generated by the IH coil. Since the heat occurs in the roller itself, the roller has excellent thermal conductivity with respect to the recording medium p. In addition, the IH coil can rise rapidly in temperature.

In addition, similar to the second embodiment shown in FIG. 3, a star wheel 136 is provided on the upper side of the heat pipe 134. The star wheel 136 is rotated while pushing the recording medium p to the heat pipe 134. Since the star wheel 136 is disposed in the heat-fixing device 120, the same effects as those in the second embodiment shown in FIG. 3 can be obtained.

As described in the above-mentioned fourth embodiment, even though the heat carrying belt 123 as shown in the second embodiment is not used, it is possible to obtain the same effect with a simple configuration by using the heat pipe 134. In addition, when the contact surface between the heat pipe 134 and the recording medium p is disposed so as to become flush with or above a line which connects the contact point between the pair of the lower roller 121 and the upper roller 124 and the recording medium p and the contact point between the pair of the lower roller 122 and the upper roller 125 and the recording medium p, the recording medium p can be applied with tension. For this reason, the surface of the heat pipe 134 is disposed so as to come into close contact with the recording medium p, so that the recording medium p can be efficiently heated.

Here, in the first embodiment to the fourth embodiment described above, as shown in FIG. 6, the heat-fixing device 120 heats the recording medium p from the opposite surface to the image-formed surface of the recording medium p, that is, the back surface of the recording medium p.

As a modified example of the first embodiment to the fourth embodiment, as shown in FIG. 7, the heat-fixing device 120 may heat the recording medium p from the image-formed surface of the recording medium p, that is, the surface side of the recording medium p. In the ink jet recording apparatus 1, even though not shown in FIG. 1, it is preferable that the recording medium p which is formed with the image on the surface be reversed to be carried to the heat-fixing device 120. According to the type of the recording medium p, when the recording medium p is heated from the image forming surface thereof, the vapor is evaporated while being moderately widened in a cross-sectional direction of the recording medium p, so that a swelling property of the fiber of the recording medium p is alleviated. In addition, the feathering or the bleed of the image can be improved, and the cockling or the curl is effectively suppressed to a low level.

As described above, according to the first embodiment to the fourth embodiment, the heat-fixing device 120 pulls the recording medium p while interposing the recording medium p between the pair of the rollers on the upstream side and the pair of the rollers on the downstream side along the carrying direction of the recording medium p, so that the cockling or the curl is effectively suppressed. At this time, when there is a slight speed difference such that a circumferential speed of the pair of the rollers on the downstream side is faster than that of the pair of the rollers on the upstream side, the effect is increased.

In addition, at least any one of the heat carrying roller 124 and the heat carrying roller 125 among the pair of the rollers on the upstream and the pair of the rollers on the downstream is a crown shape, so that the recording medium p is carried under tension more or less. For this reason, the heat-fixing device 120 efficiently evaporates the moisture while the cockling (paper wrinkle) in the recording medium p is corrected to be flattened.

In addition, with the star wheel 136, the recording medium p can be come into closer contact with the heating unit. For this reason, the heat is thoroughly propagated to the recording medium p to efficiently evaporate the moisture.

According to the ink jet recording apparatus of the embodiments, heat transfer efficiency with respect to the plain paper on which the image is formed by the aqueous ink jet ink is increased, and the moisture generated by heating is efficiently diffused to the outside while being diffused in the paper. For this reason, according to the ink jet recording apparatus of the embodiments, it is possible to provide the aqueous ink jet recording image with high quality in the plain paper.

What is claimed is:

1. An ink jet recording apparatus comprising:
an ink jet head on which a plurality of nozzles are arranged;
a sub-scan driving unit which carries a recording medium on which an image is formed;
a first carrying unit which is disposed on a downstream side of a carrying direction of the recording medium by the sub-scan driving unit and carries the recording medium on which an image is formed by the ink jet head;
a second carrying unit which is disposed on a downstream side of the first carrying unit along a carrying direction of the recording medium; and
a heating unit which is disposed between the first carrying unit and the second carrying unit.

2. The apparatus of claim 1, wherein the heating unit heats the recording medium from a lower side.

3. The apparatus of claim 1, wherein an opposite surface side to a heated surface of the recording medium by the heating unit is in an open state.

4. The apparatus of claim 1, wherein the first carrying unit and the second carrying unit carry the recording medium so as to be pulled.

5. The apparatus of claim 1, wherein the heating unit heats an image forming surface of the recording medium.

6. The apparatus of claim 1, wherein the heating unit heats an opposite surface to an image forming surface of the recording medium.

7. The apparatus of claim 1, wherein the first carrying unit includes a pair of a first upper roller and a first lower roller, and the second carrying unit includes a pair of a second upper roller and a second lower roller.

8. The apparatus of claim 7, wherein, a heat resistant carrying belt is hung on the first lower roller and the second lower roller to a heated surface side of the recording medium.

9. The apparatus of claim 8, wherein the heating unit heats the recording medium from a lower side of the carrying belt.

10. The apparatus of claim 1, further comprising a guide unit which is provided between the first carrying unit and the second carrying unit and guides the recording medium to be carried.

11. The apparatus of claim 10, wherein the heating unit is provided to a lower side of the guide unit.

12. The apparatus of claim 4, wherein the first carrying unit and the second carrying unit are applied with tension in a feeding direction of the recording medium and a width direction perpendicular to the feeding direction.

13. The apparatus of claim 7, wherein at least any one of the first upper roller and the second upper roller is a crown shape.

14. The apparatus of claim 1, further comprising an anti-float member for preventing the recording medium from floating between the first carrying unit and the second carrying unit.

15. The apparatus of claim 12, wherein the anti-float member is disposed on an opposite side to a heated surface with respect to the recording medium.

16. The apparatus of claim 14, wherein the anti-float member is a star wheel.

17. The apparatus of claim 11, wherein the heating unit is a hollow roller which is provided with a halogen heater therein.

18. A method of drying ink comprising:
forming an image with respect to a recording medium by using an ink ejected from a nozzle of an ink jet head;
carrying the recording medium during the forming the image;
after the forming the image, carrying the recording medium while two places of an upstream side and a downstream side thereof are pulled; and
heating the recording medium from a lower side, the upper side of which is in an opened state between the upstream side and the downstream side.

19. An ink jet recording apparatus comprising:
means for discharging an ink from an ink jet head on which a plurality of nozzles are arranged;
first means for carrying the recording on which an image is formed by the ink jet head, wherein the first means is disposed on a downstream side of a carrying direction of the recording medium;
second means for carrying the recording medium which is disposed on a downstream side of the first means along a carrying direction of the recording medium; and
means for heating the recording medium which is disposed between the first means and the second means.
